(19) United States
(12) Patent Application Publication
(10) Pub. No.: US 2014/0373009 A1
(43) Pub. Date: Dec. 18, 2014

(54) THREAD OPERATION ACROSS VIRTUALIZATION CONTEXTS

(71) Applicant: Microsoft Corporation, Redmond, WA (US)

(72) Inventors: Neil A. Jacobson, Acton, MA (US); Joseph Rovine, Boston, MA (US); Peter A. Morgan, Natick, MA (US); Abhishek Agarwal, Redmond, WA (US)

(21) Appl. No.: 13/917,468

(22) Filed: Jun. 13, 2013

(51) Int. Cl. G06F 9/455

(52) U.S. Cl. CPC G06F 9/455
USPC 718/1

(57) ABSTRACT

Application virtualization at the thread level, rather than at the process level. The thread is permitted to pass virtualization context boundaries. A thread might be operating in a particular virtualization context (e.g., a native environment or a first virtualization environment) having access to particular computing resources. The thread then enters an entry point for code operating in another virtualization context (e.g., a virtualization environment from a native environment, or a second virtualization environment from a first virtualization environment) having access to other computing resources. Once this happens, the thread is associated with the next virtualization context so that the thread has access to the computing resources of this next virtualization context.

### BACKGROUND

In application virtualization, an application is deployed to a client machine in a virtual environment. A virtual environment includes resources that are accessible to the application installed in that environment and includes files, registry keys, and so forth. Virtualization facilitation software intercepts many operating system Application Program Interface (API) calls (such as read request, write request, events, and so forth) that the application makes in the virtual environment. The virtualization facilitation software then redirects the calls to another location. This other location is a managed location that can be sandboxed on the client machine. Accordingly, the installation and operation of the application is isolated from the native environment of the client machine.

The virtualization facilitation software thus provides the illusion to the application installed in the virtual environment that the application is just running on the client machine in its normal environment, and thus the application has no information regarding the existence of such a virtual environment. Likewise, the operating system is also unaware of the virtual environment, but just receives API calls just as the operating system normally would.

This isolation means that an application can be cleanly installed and removed from the client machine, thus facilitating convenient application management. Furthermore, since the installed application is isolated from the native environment, the installed application is also isolated from other applications that might be running on the client machine. Thus, application virtualization permits applications to be more cleanly installed on, run in, and removed from a client machine.

Conventional application virtualization occurs at the process level. All threads of a process running in a virtual environment are also run in the virtual environment These threads have access to all the virtual resources (such as files, registry keys, and so forth) of their process, but do not have access to virtual resources of other virtual environments. Likewise, threads running within native processes do not have access to any virtual resource in any virtual environment.

### BRIEF SUMMARY

At least some embodiments described herein relate to performing application virtualization at the thread level, rather than at the process level. In particular, the thread is permitted to pass virtualization context boundaries. For instance, a thread might be operating in a particular virtualization context having access to particular computing resources. The thread then enters an entry point for code operating in another virtualization context having access to other computing resources. Once this happens, the thread is associated with the next virtualization context so that the thread has access to the computing resources of this next virtualization context.

As an example, a thread might pass from a native environment to a virtualization environment, and vice versa. For instance, a native application might execute a plug-in operating in a virtualization environment. The thread may thus transition into the virtualization environment when executing the plug-in, but otherwise be operating in the native environment. As an alternatively, a thread might transition from a first virtualization environment (such as an application deployed through application virtualization) to a second virtualization environment (such as when that virtualized application executes a plug-in).

Accordingly, application virtualization is enabled by allowing threads to cross virtualization context boundaries during the lifetime of the thread. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 abstractly illustrates a computing system in which some embodiments described herein may be employed;

FIG. 2 illustrates a computing environment in which there are two virtualization contexts, a first virtualization context and a second virtualization context;

FIG. 3 illustrates one example virtualization environment, which includes a virtualization facilitation component that intercepts function calls from threads operating in the virtualization environment, and redirects the function calls to computing resources; and

FIG. 4 illustrates a flowchart of a method for operating a thread across virtualization contexts.

### DETAILED DESCRIPTION

At least some embodiments described herein relate to performing application virtualization at the thread level, rather than at the process level. In particular, the thread is permitted to pass virtualization context boundaries. For instance, a thread might be operating in a particular virtualization context having access to particular computing resources. The thread then enters an entry point for code operating in another virtualization context having access to other computing resources. Once this happens, the thread is associated with the next virtualization context so that the thread has access to the computing resources of this next virtualization context.

As an example, a thread might pass from a native environment to a virtualization environment, and vice versa. For instance, a native application might execute a plug-in operating in a virtualization environment. The thread may thus transition into the virtualization environment when executing the plug-in, but otherwise be operating in the native environment. As an alternatively, a thread might transition from a first virtualization environment (such as an application deployed through application virtualization) to a second virtualization environment (such as when that virtualized application executes a plug-in).

Accordingly, application virtualization is enabled by allowing threads to cross virtualization context boundaries during the lifetime of the thread. This contrasts with the prior art method, in which threads of a process only run within the same virtualization context as the process itself, and the process itself is limited to one virtualization context. In the conventional process-based virtualization, the threads have access to all of the resources (such as files, registry keys, and so forth) of the parent process.

Unfortunately, the use of the prior art method substantially inhibits the use of plug-ins. When an application is installed in the native environment, the application registers associated plug-ins with the operating system. Other applications on the system can thus load and use these plug-ins. In contrast, when a virtual application is packaged, the associated plug-ins (called herein “virtual plug-ins”) exist inside the package but are not registered with the operating system. Accordingly, native processes and processes running in other virtual environments will not see the plug-in registrations and therefore are unable to load the virtual plug-ins. Furthermore, even if these virtual plug-ins were registered with the operating system, the virtual plug-ins would not work if a native process or process running in a different virtual environment loaded them since many plug-ins require access to their virtual resources which would only be available to processes running inside the virtual environment of the virtual plug-in.

Techniques to allow virtual plug-ins to be more globally available are solved by allowing threads themselves to pass between virtualization contexts (e.g., between the native environment and a virtual environment, or between different virtualization environments). When a thread executes a plug-in, the thread temporarily enters the virtualization context associated with the plug-in, giving temporary access to the environmental resources upon which the plug-in relies. Furthermore, techniques described herein also register some information in the native environment, so that all processes are aware of the virtual plug-in. More generally speaking, the principles described herein allow more flexibly processing by allowing threads to execute across virtualization context boundaries.

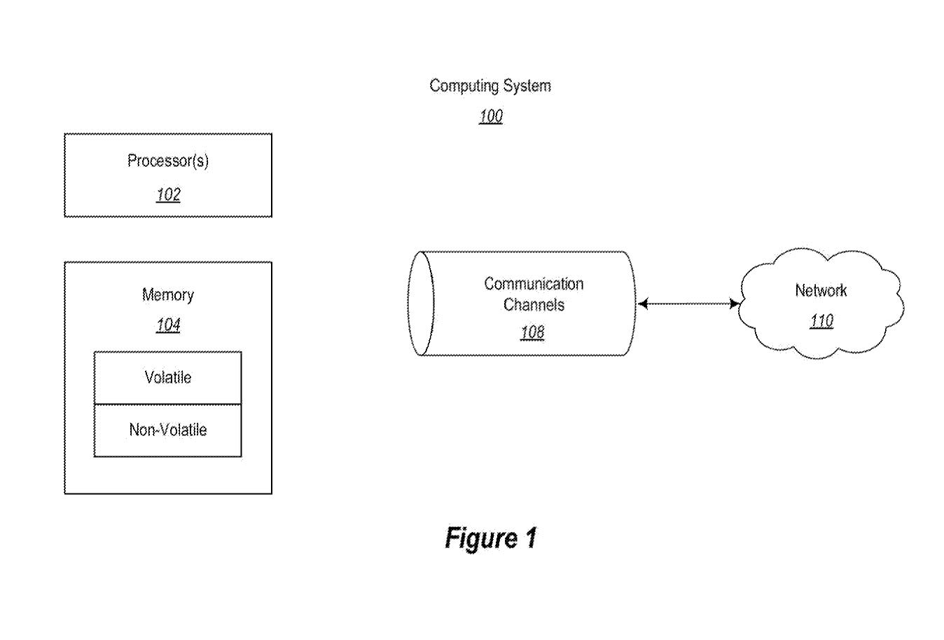

Some introductory discussion of a computing system will be described with respect to FIG. 1. Then, embodiments of allowing threads to cross virtualization context boundaries will be described with respect to subsequent figures.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other tangible medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

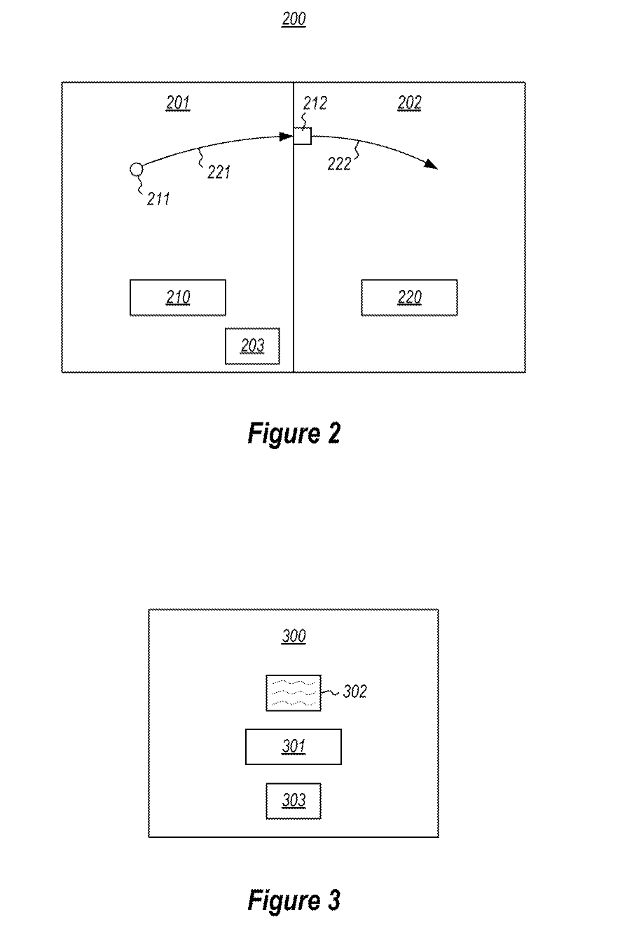

FIG. 2 illustrates a computing environment 200 in which there are two virtualization contexts, a first virtualization context 201 and a second virtualization context 202. The first virtualization context 201 has associated therewith computing resources 210. The second virtualization context 202 has associated therewith computing resources 220. While a thread is operating in the first virtualization context 201, the thread has access to the first computing resources 210, but not the second computing resources 220. While a thread is operating in the second virtualization context 202, the thread has access to the second computing resources 220, but not the first computing resources 210. Examples of computing resources 210 and 220 include files and registry keys.

The virtualization context defines a context in which an application is executed. In a typical installation, an application is installed into a native environment of the computing system. Thus, the native environment is an example of a virtualization context, in which case the virtualization resources would be simply the native resources of the operating system (such as native files, registry keys, and so forth). In contrast, in application virtualization, an application is installed in a virtual environment, in which the application does not have direct access to the native resources of the operating system. Instead, the application has access to virtualization resources. The application might have “indirect” access to the native resources of the operating system. For instance, the application might read a native resource, but if the application attempts to modify the native resource, then a copy is made within the virtual environment and the operating system resources remain unchanged. Accordingly, a virtualization environment is another example of a virtualization context. As a computing system may have any number of virtualization environments, it is possible for a computing system to have any number of virtualization contexts including a native environment, and one or more virtualization environments.

The virtualization context 201 includes a thread transition component 203 that is configured to change a virtualization context of the thread when the thread enters an entry point for code operating in a different virtualization context. For instance, as will be described in further detail below, a thread 211 operates in the first virtualization context 201, but upon encountering entry point 212, the thread transition component 203 transitions the thread 211 so that the thread then operates in the second virtualization context 202.

FIG. 3 illustrates one example virtualization environment 300, which includes a virtualization facilitation component 301 that intercepts function calls from threads 302 operating in the virtualization environment 300, and redirects the function calls to computing resources 303. From the perspective of the threads 302, the threads 302 are accessing computing resources associated with the virtualization environment. However, the actual computing resources 303 being accessed may be native resources, albeit managed to ensure that the virtualization environment does not interfere with the native environment or other virtualization environments.

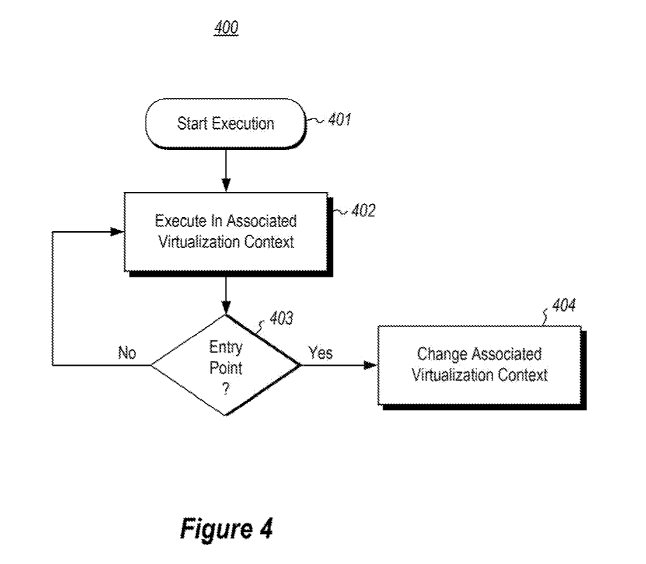

FIG. 4 illustrates a flowchart of a method 400 for operating a thread across virtualization contexts. The thread starts executing (act 401) and continues executing (act 402) in an associated virtualization context. For instance, referring to FIG. 2, the thread 211 begins executing in the first virtualization context 201. Accordingly, the thread 211 has access to the first computing resources 210, but not the second computing resources 220. This state continues as long as the thread does not pass through or encounter an entry point to code operating in a different virtualization context (“No” in decision block 403). However, if the thread encounters an entry point to code operating in a different context (“Yes” in decision block 403), the thread is then or thereafter associated with the different virtualization context (act 404), whereupon the thread continues to execute, but now in a different associated virtualization context.

For instance, referring to FIG. 2, suppose the thread 211 encounters the entry point 212 (“Yes” in decision block 403) to code executing in the second entry point (as represented by arrow 221). In that case, the second virtualization context 202 would then be associated with the thread 211 (act 404), and the thread 211 would continue to execute within the second virtualization context 202 (as represented by arrow 222). Accordingly, from that point the thread has access to the second computing resources 220, but not the first computing resources 210.

In some embodiments, the thread is associated with the different virtualization context (act 404) immediately in response to encountering the entry point (“Yes” in decision block 403). In other embodiments, the thread is associated with the different virtualization context (act 404) after encountering the entry point, and upon the occurrence of a further event. Such further event might be, for example, the thread requesting access to the virtualization resources associated with the different virtualization context.

There are several issues to note here which together lend enormous flexibility in the operation of the thread. The first point of flexibility resides in the concept that the method 300 may be performed to allow the thread to transition through any number of boundaries between virtualization contexts. Thus, for example, there may be multiple transitions represented by the arrow in FIG. 2, as the thread transitions from one virtualization context to the next, to the next, and so forth, until the thread terminates.

The second point of flexibility resides in the flexible nature of virtualization contexts. A virtualization context might be a native environment, or one of any number of possible virtualization contexts. For instance, suppose that three applications are virtualized on a computing system. The computing system would have potentially four different virtualization contexts: 1) a native environment of the computing system, 2) a virtualization environment distinct to one of the application virtualizations, 3) a virtualization environment distinct to a second of the application virtualizations, and 4) a virtualization environment distinct to the third of the application virtualizations.

Accordingly, referencing FIG. 2, the first and second virtualization contexts 201 and 202 have been left represented in the abstract, leaving the transition represented by the arrow also abstract. As examples of the abstract transition, the thread might transition from 1) a native environment to a virtualization environment, 2) from a virtualization environment to a native environment, and 3) from one virtualization environment to a second virtualization environment. Each of these transitions will now be discussed in further detail.

For instance, in a first embodiment, the first virtualization context 201 is a native environment and the second virtualization context 202 is a virtualization environment. Accordingly, the arrow in FIG. 2, represents a thread that begins operating in a native environment and then continues in a virtualization environment. As an example, the thread might be begun with a process associated with a natively installed application. That thread may then enter the virtual environment to execute a plug in associated with a virtualized application.

Accordingly, even a native application can use a plug-in associated with a virtualized application. When registering a plug-in that is part of a virtualized application package, the plug-in would be registered in the virtualized environment. However, so that natively installed applications are aware of the plug-in, enough information might also be provided to the native environment such that the natively installed application would at least be aware of the plug-in and be able to find its entry point.

In a second embodiment, the first virtualization context 201 might be a virtualization environment and the second virtualization context 202 might be a native environment. For instance, in the previous example, a thread transitioned from a native environment to a virtualization environment. This second transition could represent a return of the thread to the native environment. For instance, after the plug-in that is in the virtualization environment has been executed by the thread, the thread might be returned to the native environment for continued execution of the natively installed application.

In a third embodiment, the first virtualization context 201 might be a first virtualization environment, and the second virtualization context 202 might be a second virtualization environment. For instance, suppose that a first virtualized application is to use a plug-in provided by a second virtualized application package. In that case, the thread from the first virtualized application might use the plug-in from the second virtualized environment.

The following are examples of the first two virtualization transitions that might occur to a thread that begins in a native environment (wherein “Env.” is an abbreviation for “environment” and “Virt.” is an abbreviation for “virtualization”):

1) Native Env. to Virt. Env. and then back to the Native Env.; and
2) Native Env. to 1^{st} Virt. Env, and then to a 2^{nd} Virt. Env.

The following are examples of the first two virtualization transitions that might occur to a thread that begins in a virtualization environment:

1) Virt. Env. to Native Env. to the same Virt. Env.;
2) 1^{st} Virt. Env. to Native Env. to 2^{nd} Virt. Env.;
3) 1^{st} Virt. Env. to 2^{nd} Virt Env. to Native Env.;
4) 1^{st} Virt. Env. to 2^{nd} Virt Env. to 1^{st} Virt. Env.; and
5) 1^{st} Virt. Env. to 2^{nd} Virt. Env. to 3^{rd} Virt. Env.

The following are examples of the first three virtualization transitions that might occur to a thread that begins in a native environment:

1) Native Env. to Virt. Env. to Native Env. to Virt. Env.;
2) Native Env. to 1^{st} Virt. Env. to Native Env. to 2^{nd} Virt. Env.;
3) Native Env. to 1^{st} Virt. Env. to 2^{nd} Virt. Env. to Native Env.;
4) Native Env. to 1^{st} Virt. Env. to 2^{nd} Virt. Env. to 1^{st} Virt. Env; and
5) Native Env. to 1^{st} Virt. Env. to 2^{nd} Virt. Env. to 3^{rd} Virt. Env.

The following are examples of the first three virtualization transitions that might occur to a thread that begins in a virtualization environment:

1) Virt. Env. to Native Env. to Virt. Env. to Native Env.;
2) 1^{st} Virt. Env. to Native Env. to 1^{st} Virt. Env. to 2^{nd} Virt. Env;
3) 1^{st} Virt. Env. to Native Env. to 2^{nd} Virt. Env. to Native Env.;
4) 1^{st} Virt. Env. to Native Env. to 2^{nd} Virt. Env. to 1^{st} Virt. Env.;
5) 1^{st} Virt. Env. to Native Env. to 2^{nd} Virt. Env. to 3^{rd} Virt. Env.;
6) 1^{st} Virt. Env. to 2^{nd} Virt. Env. to Native Env. to 1^{st} Virt. Env.;
7) 1^{st} Virt. Env. to 2^{nd} Virt. Env. to Native Env. to 2^{nd} Virt. Env.;
8) 1^{st} Virt. Env. to 2^{nd} Virt. Env to Native Env. to 3^{rd} Env.;
9) 1^{st} Virt. Env. to 2^{nd} Virt. Env. to 1^{st} Virt. Env. to Native Env;
10) 1^{st} Virt. Env. to 2^{nd} Virt. Env. to 1^{st} Virt. Env. to 2^{nd} Virt. Env;
11) 1^{st} Virt. Env. to 2^{nd} Virt. Env. to 3^{rd} Virt. Env. to Native Env.;
12) 1^{st} Virt. Env. to 2^{nd} Virt. Env. to 3^{rd} Virt. Env. to 1^{st} Virt. Env.;
13) 1^{st} Virt. Env. to 2^{nd} Virt. Env. to 3^{rd} Virt. Env. to 2^{nd} Virt. Env.; and
14) 1^{st} Virt. Env. to 2^{nd} Virt. Env. to 3^{rd} Virt. Env. to 4^{th} Virt. Env.

These examples have been provided just to illustrate the great degree of flexibility that a thread may be afforded as it transitions across virtualization boundaries during the lifetime of the thread.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for operating a thread across virtualization contexts, the method comprising:
an act of a thread operating in a first virtualization context and thus having access to first computing resources associated with the first virtualization context;
an act of the thread encountering an entry point to code operating in a second virtualization context; and
after the act of the thread encountering the entry point, an act of associating the thread with a second virtualization context such that the thread has access to second computing resources associated with the second virtualization context.

2. The method in accordance with claim 1, wherein the first virtualization context is a native environment and the first computing resources are native resources, and the second virtualization context is a virtualization environment and the second computing resources are virtual resources.

3. The method in accordance with claim 1, wherein the first virtualization context is a virtualization environment and the first computing resources are virtual resources, and the second virtualization context is a native environment and the second computing resources are native resources.

4. The method in accordance with claim 1, wherein the first virtualization context is a first virtualization environment and the first computing resources are first virtual resources, and the second virtualization context is a second virtualization environment and the second computing resources are second virtual resources.

5. The method in accordance with claim 1, the entry point being a first entry point, the method further comprising:
an act of the thread encountering a second entry point to code operating in a third virtualization context;
after the act of the thread encountering the second entry point, an act of associating the thread with a third virtualization context such that the thread has access to third computing resources associated with the third virtualization context.

6. The method in accordance with claim 5, wherein the third virtualization context is the same as the first virtualization context.

7. The method in accordance with claim 5, wherein the third virtualization context is different than the first virtualization context.

8. The method in accordance with claim 1, further comprising:
an act of the thread encountering a third entry point to code operating in a fourth virtualization context;
after the act of the thread encountering the third entry point, an act of associating the thread with a third virtualization context such that the thread has access to third computing resources associated with the third virtualization context.

9. A computer program product comprising one or more computer-readable storage media having thereon one or more computer-executable instructions that are structured such that, when executed by one or more processors of a computing system, cause the computing system to perform a method for supporting operation of a thread across virtualization contexts, the method comprising:
while the thread is operating in a first virtualization context, an act of intercepting and redirecting requests from the thread such that the thread accesses first computing resources associated with the first virtualization context;
an act of detecting that the thread encounters an entry point to code operating in a second virtualization context; and
while the thread is operating in the second virtualization context, an act of intercepting and redirecting requests from the thread such that the thread accesses second computing resources associated with the second virtualization context.

10. The computer program product in accordance with claim 9, wherein the entry point is a first entry point, and the method further comprises:
an act of detecting that the thread encounters a second entry point to code operating in a third virtualization context; and
while the thread is operating in the third virtualization context, an act of intercepting and redirecting requests from the thread such that the thread accesses third computing resources associated with the third virtualization context.

11. The computer program product in accordance with claim 10, wherein the first virtualization context is a native environment, the second virtualization context is a virtualization environment, and the third virtualization context is the native environment.

12. The computer program product in accordance with claim 10, wherein the first virtualization context is a native environment, the second virtualization context is a first virtualization environment, and the third virtualization context is a second virtualization environment.

13. The computer program product in accordance with claim 10, wherein the first virtualization context is a virtualization environment, the second virtualization context is a native environment, and the third virtualization context is the virtualization environment.

14. The computer program product in accordance with claim 10, wherein the first virtualization context is a first virtualization environment, the second virtualization context is a native environment, and the third virtualization context is a second virtualization environment.

15. The computer program product in accordance with claim 10, wherein the method further comprises:
an act of detecting that the thread encounters a third entry point to code operating in a fourth virtualization context; and
while the thread is operating in the fourth virtualization context, an act of intercepting and redirecting requests from the thread such that the thread accesses fourth computing resources associated with the third virtualization context.

16. The computer program product in accordance with claim 15, wherein the first and third virtualization contexts are the same.

17. The computer program product in accordance with claim 16, wherein the second and fourth virtualization contexts are the same.

18. The computer program product in accordance with claim 15, wherein the first and fourth virtualization contexts are the same.

19. A computing system comprising:
a first virtualization context comprising first computing resources;
a second virtualization context comprising second computing resources virtual resources;
a virtualization facilitation component that intercepts function calls from one or more threads operating in either or both of the first and second virtualization contexts, and redirects the function calls to the first and second computing resources, respectively; and
a thread transition component configured to change a virtualization context of the thread when the thread enters an entry point for code operating in a different virtualization context.

20. The computing system in accordance with claim 19, wherein the first virtualization context is a native environment, and the second virtualization context is a virtualization context, wherein the virtualization component intercepts function calls from one or more threads operating in the virtual environment and redirects the function calls to the virtualization environment.
